(19) United States
(12) Patent Application Publication
(10) Pub. No.: US 2014/0265031 A1
(43) Pub. Date: Sep. 18, 2014

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND PROCESS FOR MAKING FLEXOGRAPHIC PRINTING PLATE

(71) Applicant: FUJIFILM CORPORATION, Tokyo (JP)

(72) Inventors: Hayato YOSHIDA, Haibara-gun (JP); Atsushi SUGASAKI, Haibara-gun (JP)

(73) Assignee: FUJIFILM CORPORATION, Tokyo (JP)

(21) Appl. No.: 14/202,134

(22) Filed: Mar. 10, 2014

(30) Foreign Application Priority Data
Mar. 12, 2013 (JP) 2013-048567

(51) Int. Cl. B41N 1/12

(52) U.S. Cl. CPC B41N 1/12
USPC 264/400; 524/555; 524/572; 524/571

(57) ABSTRACT

A resin composition for laser engraving, comprises (Component A) an ethylenically unsaturated group-containing binder polymer; and (Component B) a tertiary ester group- and ethylenically unsaturated group-containing compound. The tertiary ester group in Component B is preferably a group represented by Formula (I).

[chemical structure]

In Formula (I), R¹ to R³ independently denote a monovalent hydrocarbon group, at least two of R¹ to R³ may be bonded to each other to from at least one ring structure, and the wavy line portion denotes a position of bonding to another moiety.

### CROSS REFERENCE TO RELATED APPLICATIONS

This application claims priority under U.S.C. 119 from Japanese Patent Application No. 2013-048567 filed on Mar. 12, 2013, the entire content of which is incorporated by reference herein.

### TECHNICAL FIELD

The present invention relates to a resin composition for laser engraving, a flexographic printing plate precursor for laser engraving and a process for produc ing the same, and a process for making a flexographic printing plate.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a resin composition for laser engraving, those described in JP-A-2009-6652 (JP-A denotes a Japanese unexamined patent application publication), JP-A-2011-136430, or JP-A-2010-69763 are known.

### DISCLOSURE OF THE PRESENT INVENTION

### Problems that the Present Invention is to Solve

It is an object of the present invention to provide a resin composition for laser engraving that has excellent rinsing properties for engraving residue generated when laser engraving and that can give a plate having excellent rubber elasticity and strength, a flexographic printing plate precursor and a process for producing same employing the resin composition for laser engraving, and a flexographic printing plate and a process for making same.

### Means for Solving the Problems

The object of the present invention has been attained by means described in <1>, <11>˜<16> below. They are described below together with <2> to <10> and <16>, which are preferred embodiments.

<1> A resin composition for laser engraving, comprising: (Component A) an ethylenically unsaturated group-containing binder polymer; and (Component B) a tertiary ester group- and ethylenically unsaturated group-containing compound.

<2> The resin composition for laser engraving according to <1>, wherein the tertiary ester group is a group represented by Formula (I)

[chemical structure]

wherein in Formula (I) R¹ to R³ independently denote a monovalent hydrocarbon group, at least two of R¹ to R³ may be bonded to each other to form at least one ring structure, and the wavy line portion denotes a position of bonding to another moiety.

<3> The resin composition for laser engraving according to <1> or <2>, wherein it further comprises (Component C) a polymerizable compound other than Component A and Component B.

<4> The resin composition for laser engraving according to any one of <1> to <3>, wherein it further comprises (Component D) a polymerization initiator.

<5> The resin composition for laser engraving according to any one of <1> to <4>, wherein it further comprises (Component E) a photothermal conversion agent.

<6> The resin composition for laser engraving according to any one of <1> to <5>, wherein Component A is a polymer selected from the group consisting of a conjugated diene-based polymer, a terminal ethylenically unsaturated group-containing conjugated diene-based polymer, and an ethylenically unsaturated group-containing polyurethane resin.

<7> The resin composition for laser engraving according to any one of <1> to <6>, wherein Component A has a content of 5 to 90 mass %.

<8> The resin composition for laser engraving according to any one of <1> to <7>, wherein Component B is a tertiary ester group-containing (meth)acrylate compound.

<9> The resin composition for laser engraving according to any one of <1> to <8>, wherein Component B is a monofunctional ethylenically unsaturated compound.

<10> The resin composition for laser engraving according to any one of <1> to <9>, wherein Component B has a content of 5 to 50 mass % relative to 100 parts by mass of Component A.

<11> A flexographic printing plate precursor for laser engraving comprising a relief-forming layer comprising the resin composition for laser engraving according to any one of <1> to <10>.

<12> A flexographic printing plate precursor for laser engraving comprising a crosslinked relief-forming layer formed by crosslinking by means of heat a relief-forming layer comprising the resin composition for laser engraving according to any one of <1> to <10>.

<13> A process for producing a flexographic printing plate precursor for laser engraving, the process comprising: a layer formation step of forming a relief-forming layer comprising the resin composition for laser engraving according to any one of <1> to <10>; and a crosslinking step of crosslinking the relief-forming layer by means of heat to thus obtain a flexographic printing plate precursor comprising a crosslinked relief-forming layer.

<14> A process for making a flexographic printing plate, the process comprising: a step of preparing the flexographic printing plate precursor for laser engraving according to <11> or <12>; and an engraving step of laser-engraving the crosslinked relief-forming layer to thus form a relief layer.

<15> A process for making a flexographic printing plate, the process comprising: a step of preparing a flexographic printing plate precursor for laser engraving obtained by the production process according to <13>; and an engraving step of laser-engraving the crosslinked relief-forming layer to thus form a relief layer.

<16> The process for making a flexographic printing plate according to <14> or <15>, wherein it further comprises a rinsing step of rinsing the relief layer surface with an aqueous rinsing liquid after the engraving step.

### Effects of the Invention

In accordance with the present invention, there can be provided a resin composition for laser engraving that has excellent rinsing properties for engraving residue generated when laser engraving and that can give a plate having excellent rubber elasticity and strength, a flexographic printing plate precursor and a process for producing same employing the resin composition for laser engraving, and a flexographic printing plate and a process for making same.

### Mode for Carrying Out the Present Invention

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit. In addition, ‘mass %’ and ‘parts by mass’ have the same meanings as ‘wt %’ and ‘parts by weight’ respectively The (meth)acryloyl group referred to here means either an acryloyl group or a methacryloyl group or both thereof.

Furthermore, ‘(Component A) binder polymer having an ethylenically unsaturated group’ etc. are simply called ‘Component A’ etc.

### (Resin Composition for Laser Engraving)

The resin composition for laser engraving of the present invention (hereinafter, also called simply a ‘resin composition’) comprises (Component A) an ethylenically unsaturated group-containing binder polymer and (Component B) a tertiary ester group- and ethylenically unsaturated group-containing compound.

As a result of an intensive investigation by the present inventors, it has been found that in accordance with the use of Component A and Component B in combination in the resin composition for laser engraving, there can be provided a resin composition for laser engraving that has excellent rinsing properties for engraving residue generated when laser engraving and that can give a plate, such as a flexographic printing plate precursor or a flexographic printing plate, that has excellent rubber elasticity and strength.

Although the detailed mechanism is unclear, it is surmised that a tertiary ester group due to Component B easily decomposes upon laser engraving, and rinsing properties for engraving residue improve due to the ease of decomposition and/or generation of an acid group by the decomposition; it is also surmised that since both Component A and Component B form a crosslinked structure, a film, such as a crosslinked relief layer or a relief layer, that exhibits toughness and good rubber elasticity can be obtained.

In the present specification, with respect to explanation of the flexographic printing plate precursor, a non-crosslinked crosslinkable layer comprising Component A and Component B and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving of the present invention are explained below.

### (Component A) Ethylenically Unsaturated Group-Containing Binder Polymer

The resin composition for laser engraving of the present invention comprises (Component A) an ethylenically unsaturated group-containing binder polymer.

The ethylenically unsaturated group in Component A is not particularly limited, but is preferably a (meth)acryloyl group or an ethylenically unsaturated group derived from a conjugated diene in a conjugated diene polymer. When in this mode, a uniform crosslinked film is obtained and a film that is tough and exhibits good rubber elasticity is obtained.

Component A is preferably a plastomer at 20° C.

The ‘plastomer’ referred to in the present invention means a polymer that has the property, as described in ‘New Polymer Dictionary’ edited by the Society of Polymer Science, Japan (Asakura Shoten, Japanese, published in 1988), of easily flowing and deforming upon heating and solidifying in the deformed shape upon cooling. The term plastomer is the opposite of an elastomer (which has the property, when an external force is applied, of changing its shape in response to the external force and recovering its original shape in a short time when the external force is removed).

In the present invention, a plastomer means one for which, when its original size is 100%, it can be deformed up to 200% by means of a small external force at room temperature (20° C.) and its shape will not return to 130% or below even if the external force is removed. In more detail, it means a polymer that can be stretched twice the distance between pre-stretch reference lines on an I-shaped test piece in a tensile test at 20° C. in accordance with a tensile set test of JIS K 6262-1997, and that has a tensile set of at least 30% when 5 min. has elapsed after the tensile external force is removed after the stretched state of twice the distance between the pre-stretch reference lines is held for 5 min.

In the case of a polymer for which the above measurement cannot be performed, a polymer that deforms even when an external force is not applied and does not return to its original shape corresponds to a plastomer, and examples that correspond to this include resins in a syrup form, an oil form, and a liquid form.

Furthermore, Component A preferably has a glass transition temperature (Tg) of no greater than 20° C. from the viewpoint of exhibition of flexibility and rubber elasticity. In the case of a polymer having two or more Tgs, all of the Tgs are preferably no greater than 20° C.

The glass transition temperature (Tg) of Component A should be measured by DSC (differential scanning calorimetry).

Component A is not particularly limited as long as it is an ethylenically unsaturated group-containing polymer compound, but is preferably a polymer selected from the group consisting of a conjugated diene-based polymer, a terminal ethylenically unsaturated group-containing conjugated diene-based polymer, and an ethylenically unsaturated group-containing polyurethane resin; from the viewpoint of cost it is more preferably a conjugated diene-based polymer, and from the viewpoint of adjustment of physical properties and diversity it is more preferably a polymer selected from the group consisting of a terminal ethylenically unsaturated group-containing conjugated diene-based polymer and an ethylenically unsaturated group-containing polyurethane resin.

Furthermore, Component A is more preferably a polymer selected from the group consisting of a conjugated diene-based polymer, a terminal (meth)acryloyl group-containing conjugated diene-based polymer, and a (meth)acryloyl group-containing polyurethane resin.

Examples of the conjugated diene-based polymer include a polymer obtained by polymerization of a conjugated diene-based hydrocarbon and a copolymer obtained by polymerization of a conjugated diene-based hydrocarbon and a monoolefin-based unsaturated compound.

Specific examples of the conjugated diene-based hydrocarbon include 1,3-butadiene, isoprene, and chloroprene. With regard to these compounds, they may be used on their own or in a combination of two or more types.

Specific examples of the monoolefin-based unsaturated compound include styrene, α-methylstyrene, o-methylstyrene, p-methylstyrene, acrylonitrile, methacrylonitrile, vinyl chloride, vinylidene chloride, acrylamide, methacrylamide, vinyl acetate, an acrylic acid ester, a methacrylic acid ester, acrylic acid, and methacrylic acid.

Specific examples of polymers obtained by polymerization of the conjugated diene-based hydrocarbon and copolymers obtained by copolymerization of the conjugated diene-based hydrocarbon and the monoolefin-based unsaturated compound include, but are not particularly limited to, polybutadiene, polyisoprene, polychloroprene, a styrene-butadiene copolymer, a styrene-isoprene polymer, a styrene-chloroprene copolymer, an acrylonitrile-butadiene copolymer, an acrylonitrile-isoprene copolymer, an acrylonitrile-chloroprene copolymer, an acrylic acid ester-isoprene copolymer, an acrylic acid ester-chloroprene copolymer, a copolymer between a methacrylic acid ester and the conjugated diene, an acrylonitrile-butadiene-styrene copolymer, a styrene-isoprene-styrene block polymer, and a styrene-butadiene-styrene block polymer. These polymers may be formed by emulsion polymerization or solution polymerization.

Furthermore, examples of a (meth)acrylate group-containing conjugated diene-based polymer include a polyisoprene into which a methacrylate has been introduced (Kuraprene UC-203, UC-102, Kuraray Co., Ltd.).

Moreover, a terminal ethylenically unsaturated group-containing conjugated diene-based polymer is also preferably used. Examples of the terminal ethylenically unsaturated group-containing conjugated diene-based polymer include a polybutadiene into which a (meth)acrylate group has been introduced (NISSO-PB TEAI-1000, EMA-3000, Nippon Soda Co., Ltd.).

Among them, the conjugated diene-based polymer or terminal ethylenically unsaturated group-containing conjugated diene-based polymer is preferably polyisoprene, polybutadiene, a terminal (meth)acryloyl group-containing polyisoprene, or a terminal (meth)acryloyl group-containing polybutadiene, more preferably polyisoprene or a terminal (meth)acryloyl group-containing polybutadiene, and yet more preferably isoprene.

Examples of the ethylenically unsaturated group-containing polyurethane resin include, but are not particularly limited to, a urethane (meth)acrylate.

The urethane (meth)acrylate may be derived from, for example, a polyurethane resin having a hydroxy group at a molecular terminal or in a molecular main chain.

The polyurethane resin having a hydroxy group at a molecular terminal as a starting material may be formed by reacting at least one type of polyisocyanate and at least one type of polyhydric alcohol component.

The polyurethane resin having a hydroxy group at a molecular terminal preferably further has in the molecule at least one type of bond selected from a carbonate bond and an ester bond. It is preferable for this polyurethane resin to have the bond since the durability of a printing plate toward an ink cleaning agent containing an ester-based solvent or an ink cleaning agent containing a hydrocarbon-based solvent used in printing improves.

A method for producing the polyurethane resin having a hydroxy group at a molecular terminal is not particularly limited; examples thereof include a method in which a compound having a molecular weight of on the order of several thousand and having a carbonate bond or an ester bond and a plurality of reactive groups such as a hydroxy group, an amino group, an epoxy group, a carboxyl group, an acid anhydride group, a ketone group, a hydrazine residue, an isocyanate group, an isothiocyanate group, a cyclic carbonate group, or an alkoxycarbonyl group is reacted with a compound having a plurality of functional groups that can form a bond with the reactive group (e.g. a polyisocyanate having a hydroxy group, an amino group, etc.) so as to adjust the molecular weight, convert a molecular terminal into a bonding group, etc.

Examples of a carbonate bond-containing diol compound used in production of the polyurethane resin having a hydroxy group at a molecular terminal include aliphatic polycarbonate diols such as a 4,6-polyalkylene carbonate diol, an 8,9-polyalkylene carbonate diol, and a 5,6-polyalkylene carbonate diol. Furthermore, an aliphatic polycarbonate diol having an aromatic molecular structure within the molecule may be used. A urethane bond may be introduced by a condensation reaction between a terminal hydroxy group of these compounds and a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, triphenylmethane diisocyanate, or a triisocyanate compound such as triphenylmethane triisocyanate, 1-methylbenzene-2,4,6-triisocyanate, naphthaline-1,3,7-triisocyanate, or biphenyl-2,4,4′-triisocyanate.

A urethane (meth)acrylate, etc. may be obtained as a commercial product such as, for example, UV-3200B, UV-3000B, UV-3700B, UV-3210EA, or UV-2000B of the Shikoh (registered trademark) series (all from The Nippon Synthetic Chemical Industry Co., Ltd.), EBECRYL 230 or EBECRYL 9227EA (both from Daicel-Cytec Company Ltd.), or AU-3040, AU-3050, AU-3090, AU-3110, or AU-3120 of the Hi-Coap AU (registered trademark) series (all from Tokushiki Co., Ltd.).

As an alternative method for obtaining a urethane (meth)acrylate, etc., there is for example a method in which the polyisocyanate compound and the (meth)acryloyloxy group-containing diol compound are subjected to a polyaddition reaction to thus form a polyurethane.

Preferred examples of the (meth)acryloyloxy group-containing diol compound used in this case include Blemmer-GLM manufactured by NOF Corporation, and DA-212, DA-250, DA-721, DA-722, DA-911M, DA-920, DA-931, DM-201, DM-811, DM-832, and DM-851 of the ‘Denacol Acrylate (registered trademark)’ series manufactured by Nagase ChemteX Corporation.

The molecular weight of Component A is preferably 1,000 to 1,000,000 as a number-average molecular weight (GPC, on a polystyrene basis), more preferably 1,500 to 100,000, and yet more preferably 2,000 to 50,000. It is preferable for the number-average molecular weight of Component A to be in this range since processing of the resin composition for laser engraving comprising Component A is easy and a flexographic printing plate precursor and flexographic printing plate having excellent strength are obtained.

The number-average molecular weight of Component A is determined by measurement using a GPC (gel permeation chromatograph) method and a standard polystyrene calibration curve.

In the present invention, with regard to Component A, one type may be used on its own or two or more types may be used in combination.

In the resin composition for laser engraving of the present invention, the content of Component A is preferably 1 to 99 mass % of the total solids content, more preferably 5 to 90 mass %, yet more preferably 10 to 85 mass %, and particularly preferably 40 to 85 mass %. The ‘solids content’ referred to here means components that remain after removing volatile components such as solvent from the resin composition for laser engraving.

When the content of Component A is in this range, a film that is highly resistant to ink, tough, and highly flexible can be obtained.

### (Component B) Tertiary Ester Group- and Ethylenically Unsaturated Group-Containing Compound

The resin composition for laser engraving of the present invention comprises (Component B) a tertiary ester group- and ethylenically unsaturated group-containing compound.

The tertiary ester group in Component B means a tertiary alcohol-derived ester group (tertiary alcohol ester group).

The molecular weight of Component B is preferably no greater than 1,000 from the viewpoint of engraving sensitivity and volatility of engraving residue, more preferably no greater than 500, and yet more preferably no greater than 300. It is also preferably at least 128.

The ethylenically unsaturated group in Component B is not particularly limited but is preferably a (meth)acrylic group, and more preferably a (meth)acryloyl group, that is, Component B being a tertiary ester group-containing (meth)acrylate compound. When in this mode, the crosslinking properties are excellent, and the strength of a plate is excellent.

The number of ethylenically unsaturated groups in Component B is not particularly limited but, from the viewpoint of achieving a balance between the rubber elasticity and the strength of a plate, is preferably 1 to 4, more preferably 1 or 2, and particularly preferably 1, that is, Component B being a monofunctional ethylenically unsaturated compound.

The tertiary ester group in Component B is preferably a group represented by Formula (I).

[chemical structure]

In Formula (I), R¹ to R³ independently denote a monovalent hydrocarbon group, at least two of R¹ to R³ may be bonded to each other to from at least one ring structure, and the wavy line portion denotes a position of bonding to another moiety.

The monovalent hydrocarbon group denoted by R¹ to R³ may be either a saturated or unsaturated hydrocarbon group and includes an alkyl group having 1 to 20 carbons, an alkenyl group having 2 to 20 carbons, an alkynyl group having 2 to 20 carbons, an aralkyl group having 7 to 20 carbons, and an aryl group having 6 to 20 carbons. These groups may be either linear, branched, or cyclic and may have a substituent. Examples of the substituent include an alkyl group having 1 to 20 carbons, an alkenyl group having 2 to 20 carbons, an alkynyl group having 2 to 20 carbons, an aralkyl group having 7 to 20 carbons, an aryl group having 6 to 20 carbons, an alkoxy group having 1 to 20 carbons, an aryloxy group having 6 to 20 carbons, a halogen atom, a hydroxy group, an amino group, an amide group, a carboxyl group, a sulfonic acid group, a phosphoric acid group, and an acyloxy group.

The monovalent hydrocarbon group denoted by R¹ to R³ is preferably an alkyl group having 1 to 20 carbons, an aralkyl group having 7 to 20 carbons, or an aryl group having 6 to 20 carbons, and more preferably an alkyl group having 1 to 20 carbons.

The monovalent hydrocarbon group denoted by R¹ to R³ is preferably a hydrocarbon group having 1 to 20 carbons and, from the viewpoint of improvement of thermal decomposability or ease of a decomposition product scattering as a gas, is more preferably a hydrocarbon group having 1 to 6 carbons, and yet more preferably an alkyl group having 1 to 3 carbons; still more preferably all of R¹ to R³ are hydrocarbon groups having one carbon (that is, methyl groups).

Furthermore, in Formula (I), when at least two of R¹ to R³ are bonded to each other to form at least one ring structure, the number of atoms contained in the ring structure is preferably no greater than 40 and, from the viewpoint of maintaining good film properties, more preferably no greater than 30 and yet more preferably at least 5 but no greater than 25.

Component B is preferably a compound represented by Formula (II), and more preferably a compound represented by Formula (III).

[chemical structure]

In Formula (II) and Formula (III), R¹ to R³ independently denote a monovalent hydrocarbon group, at least two of R¹ to R³ may be bonded to each other to form at least one ring structure, R denotes a hydrogen atom or a methyl group, and L denotes a single bond or a divalent linking group.

R¹ to R³ in Formula (II) and Formula (III) have the same meanings as those of R¹ to R³ in Formula (I), and preferred modes are also the same.

R is preferably a methyl group.

A divalent linking group denoted by L comprises carbon and hydrogen atoms and is preferably formed by further combining as necessary an atom selected from the group consisting of an oxygen atom, a nitrogen atom, and a sulfur atom, and is more preferably a divalent linking group that may be formed by further combining —O—, —S—, or —NH— as appropriate with a carbonyl group (—C(═O)—), an ester bond (—C(═O)—O—), an amide bond (—C(═O)—NH—), a urethane bond (—NIT-C(═O)—O—), a urea bond (—NR′—C(═O)—NR′—), an alkylene group having 1 to 20 carbons, an arylene group having 6 to 20 carbons, or a group formed by combining the above. R′ denotes a hydrogen atom, an alkyl group having 1 to 20 carbons, or an aryl group having 6 to 20 carbons and is preferably a hydrogen atom or an alkyl group, and more preferably a hydrogen atom.

The number of carbons forming a linking chain contained in the divalent linking group is preferably no greater than 60 and, from the viewpoint of maintaining good film properties, more preferably no greater than 50 and yet more preferably no greater than 40.

Furthermore, L is preferably a single bond, an alkylene group having 1 to 20 carbons, an arylene group having 6 to 20 carbons, or a group formed by combining at least two structures selected from the group consisting of an alkylene group having 1 to 20 carbons, an arylene group having 6 to 20 carbons, an ester bond, an amide bond, a urethane bond, and a urea bond, is more preferably a single bond, an alkylene group having 1 to 20 carbons, an arylene group having 6 to 20 carbons, or a group formed by combining at least two structures selected from the group consisting of an alkylene group having 1 to 20 carbons, an ester bond, and an amide bond, is yet more preferably a single bond or a group formed by combining at least two structures selected from the group consisting of an alkylene group having 1 to 20 carbons, an ester bond, and an amide bond, and is particularly preferably a single bond.

Preferred examples of Component B include the compounds shown below, but Component B should not be construed as being limited thereto. In the compounds below, R denotes a hydrogen atom or a methyl group.

[chemical structure]

[chemical structure]

[chemical structure]

[chemical structure]

[chemical structure]

Among them, Component B is more preferably a compound listed below. Among the compounds below, R denotes a hydrogen atom or a methyl group.

[chemical structure]

Component B is particularly preferably t-butyl (meth)acrylate.

With regard to Component B, one type may be used on its own or two or more types may be used in combination.

The content of Component B in the resin composition for laser engraving is preferably 1 to 70 parts by mass relative to 100 parts by mass of Component A, more preferably 5 to 50 parts by mass, yet more preferably 10 to 30 parts by mass, and particularly preferably 10 to 20 parts by mass. When in this mode a film, such as a crosslinked relief layer or a relief layer, that has higher breaking strength and exhibits better rubber elasticity is obtained.

The resin composition for laser engraving of the present invention comprises Component A and Component B as essential components and may comprise another component. Examples of the other component include, but are not limited to, (Component C) a polymerizable compound other than Component A and Component B, (Component D) a polymerization initiator, (Component E) a photothermal conversion agent, (Component F) a fragrance, (Component G) a solvent, (Component H) a filler, and (Component I) a binder polymer other than Component A.

(Component C) Polymerizable Compound Other than Component a and Component B

The resin composition for laser engraving of the present invention preferably comprises (Component C) a polymerizable compound other than Component A and Component B in order to promote formation of a crosslinked structure. Due to it comprising Component C a film, such as a crosslinked relief layer or a relief layer, that has higher breaking strength is obtained.

Component C is preferably a radically polymerizable compound, and more preferably an ethylenically unsaturated compound.

Furthermore, Component C preferably comprises a polyfunctional ethylenically unsaturated compound and may comprise a monofunctional ethylenically unsaturated compound together with the polyfunctional ethylenically unsaturated compound, but is more preferably a polyfunctional ethylenically unsaturated compound.

The resin composition for laser engraving of the present invention preferably comprises as Component C a polyfunctional ethylenically unsaturated compound. When in this mode a film, such as a crosslinked relief layer or a relief layer, that has higher breaking strength is obtained.

The polyfunctional ethylenically unsaturated compound is preferably a compound having 2 to 20 terminal ethylenically unsaturated groups. A group of such compounds is widely known in the present industrial field, and in the present invention these compounds may be used without particular limitations. They have a chemical configuration such as for example a monomer, a prepolymer, that is, a dimer, a trimer, or an oligomer, a copolymer thereof, or a mixture thereof.

Examples of a compound from which the ethylenically unsaturated group in the polyfunctional ethylenically unsaturated compound is derived include an unsaturated carboxylic acid (e.g. acrylic acid, methacrylic acid, itaconic acid, crotonic acid, isocrotonic acid, maleic acid, etc.), and an ester or amide thereof. An ester between an unsaturated carboxylic acid and an aliphatic polyhydric alcohol compound and an amide between an unsaturated carboxylic acid and an aliphatic polyvalent amine compound are preferably used. Furthermore, an addition reaction product between a polyfunctional isocyanate or an epoxy and an unsaturated carboxylic acid ester or amide having a nucleophilic substituent such as a hydroxy group or an amino group and a dehydration-condensation reaction product with a polyfunctional carboxylic acid are also suitably used. Furthermore, an addition reaction product between a monofunctional or polyfunctional alcohol or amine and an unsaturated carboxylic acid ester or amide having an electrophilic substituent such as an isocyanate group or an epoxy group, and a substitution reaction product between a monofunctional or polyfunctional alcohol or amine and an unsaturated carboxylic acid ester or amide having a leaving substituent such as a halogen group or a tosyloxy group are also desirable. As another example, a group of compounds formed by replacing the unsaturated carboxylic acid with a vinyl compound, an allyl compound, an unsaturated phosphonic acid, or styrene may also be used.

The ethylenically unsaturated group contained in the polyfunctional ethylenically unsaturated compound is preferably an acrylate, methacrylate, vinyl compound, or allyl compound residue from the viewpoint of reactivity. Furthermore, from the viewpoint of printing durability, the polyfunctional ethylenically unsaturated compound preferably comprises at least three ethylenically unsaturated groups.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanate groups per molecule described in JP-B-48-41708.

CH₂═C(R)COOCH₂CH(R′)OH (ii)
(R and R′ independently denote H or CH₃.)

Furthermore, urethane acrylates described in JP-A-51-37193, JP-B-2-32293 and JP-B-2-16765, urethane compounds having an ethylene oxide-based skeleton described in JP-B-58-49860, JP-B-56-17654, JP-B-62-39417 and JP-B-62-39418 are also preferable.

Furthermore, by use of addition-polymerizable compounds having an amino structure in the molecule described in JP-A-63-277653, JP-A-63-260909, and JP-A-1-105238, a resin composition for laser engraving which can crosslink in a short time can be obtained.

Other examples of the polyfunctional ethylenically unsaturated compound include polyester acrylates such as those described in JP-A-48-64183, JP-B-49-43191, and JP-B-52-30490, and polyfunctional acrylates and methacrylates such as epoxy acrylates etc. formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Examples of the vinyl compounds include butanediol-1,4-divinyl ether, ethylene glycol divinyl ether, 1,2-propanediol divinyl ether, 1,3-propanediol divinyl ether, 1,3-butanediol divinyl ether, 1,4-butanediol divinyl ether, neopentyl glycol divinyl ether, trimethylolpropane tirvinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylenevinyl ether, ethylene glycol dipropylenevinyl ether, trimethylolpropane triethylenevinyl ether, trimethylolpropane diethylenevinyl ether, pentaerythritol diethylenevinyl ether, pentaerythritol triethylenevinyl ether, pentaerythritol tetraethylenevinyl ether, 1,1,1-tris[4-(2-vinyloxyethoxy)phenyl]ethane, bisphenol A divinyloxyethyl ether, divinyl adipate, etc.

Examples of the allyl compounds include polyethylene glycol diallyl ether, 1,4-cyclohexane diallyl ether, 1,4-diethylcyclohexyl diallyl ether, 1,8-octane diallyl ether, trimethylolpropane diallyl ether, trimethylolethane triallyl ether, pentaerythritol triallyl ether, pentaerythritol tetraallyl ether, dipentaerythritol pentaallyl ether, dipentaerythritol hexaallyl ether, diallyl phthalate, diallyl terephthalate, diallyl isophthalate, triallyl isocyanurate, triallyl phosphate, etc.

Particularly, since the intersolubility and cross-linking reactivity of Component A and Component B is excellent, Component C is more preferably a (meth)acrylate compound from the viewpoint of increasing the engraving sensitivity.

Among these, preferred examples of Component C include diethylene glycol di(meth)acrylate, dipentaerythritol hexa(meth)acrylate, tricyclodecanedimethanol di(meth)acrylate, trimethylolpropane tri(meth)acrylate, pentaerythritol tetra(meth)acrylate, and 1,6-hexanediol di(meth)acrylate.

The resin composition for laser engraving of the present invention may comprise a monofunctional ethylenically unsaturated compound, but if the resin composition comprises a monofunctional ethylenically unsaturated compound, it is preferable that the resin composition comprise a monofunctional ethylenically unsaturated compound in combination with a polyfunctional ethylenically unsaturated compound.

Examples of the monofunctional ethylenically unsaturated compound having one ethylenically unsaturated bond in the molecule include esters of unsaturated carboxylic acids (for example, acrylic acid, methacrylic acid, itaconic acid, crotonic acid, isocrotonic acid, and maleic acid) and monohydric alcohol compounds, and amides of unsaturated carboxylic acids and monovalent amine compounds.

Furthermore, addition reaction products of an unsaturated carboxylic acid ester or amide having a nucleophilic substituent such as a hydroxyl group, an amino group or a mercapto group, and an isocyanate or an epoxide, and dehydration condensation reaction products with a monofunctional or polyfunctional carboxylic acid, are also suitably used.

Furthermore, addition reaction products of an unsaturated carboxylic acid ester or amide having an electrophilic substituent such as an isocyanato group or an epoxy group, and an alcohol, an amine or a thiol, and substitution reaction products of an unsaturated carboxylic acid ester or amide having a detachable substituent such as a halogeno group or a tosyloxy group, and an alcohol, an amine or a thiol, are also suitable.

Also, as other examples, a group of compounds substituted with unsaturated phosphonic acid, styrene, vinyl ether or the like instead of the unsaturated carboxylic acid described above, can also be used.

The polymerizable compound is not particularly limited, and various known compounds can be used in addition to the compounds exemplified above. For example, those compounds described in JP-A-2009-204962 and the like may also be used.

The resin composition for laser engraving of the present invention may use only one kind of Component C, or may use two or more kinds of Component C in combination.

The total content of Component C in the resin composition for laser engraving of the present invention is preferably 0.1 mass % to 40 mass %, and more preferably in the range of 1 mass % to 20 mass %, relative to the total solids content of the resin composition from the viewpoint of the flexibility and brittleness of the crosslinked film.

Furthermore, the total content of Component C in the resin composition for laser engraving of the present invention is preferably 1 to 40, more preferably 2 to 30, and yet more preferably 5 to 20, relative to 100 parts by mass of Component

A from the viewpoint of the flexibility and brittleness of the crosslinked film.

### (Component D) Polymerization Initiator

In order to promote formation of a crosslinked structure, the resin composition for laser engraving of the present invention preferably comprises (Component D) a polymerization initiator, and more preferably Component C and Component D.

With regard to the polymerization initiator, one known to a person skilled in the art may be used without any limitations. A radical polymerization initiator, which is a preferred polymerization initiator, is explained in detail below, but the present invention should not be construed as being limited by these descriptions.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (I) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (I) azo compounds preferably include the following compounds.

### (c) Organic Peroxides

Preferred examples of the organic peroxide (c) as a radical polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butylperoxyisophthalate, t-butylperoxybenzoate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, t-butylperoxy-2-ethylhexylmonocarbonate, and dicumyl peroxide.

### (I) Azo Compounds

Preferable (I) azo compounds as a radical polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

It has been found that in the present invention the organic peroxide (c) above is preferable as a thermopolymerization initiator in the present invention from the viewpoint of the crosslinkablility of the film (relief-forming layer), and as an unexpected effect it is particularly preferable from the viewpoint of improvement of engraving sensitivity.

From the viewpoint of engraving sensitivity, combined use of an organic peroxide and a photothermal conversion agent, which is described later, in combination is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component A etc. occurs synergistically.

With regard to Component D in the resin composition of the present invention, only one type thereof may be used or two or more types thereof may be used in combination.

The content of Component D in the resin composition for laser engraving of the present invention is preferably 0.05 to 5 mass %, more preferably 0.1 to 3 mass %, and particularly preferably 0.5 to 1.5 mass %, relative to the total mass content of the resin composition.

### (Component E) Photothermal Conversion

The resin composition for laser engraving of the present invention preferably comprises (Component E) a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, Spezialschwarz (registered trademark) 4 (Degussa), and #45L (Mitsubishi Chemical Corporation).

The carbon black that can be used in the present invention has preferably a dibutyl phthalate (DBP) absorption number of less than 150 mL/100 g, more preferably no greater than 100 mL/100 g, and yet more preferably no greater than 70 mL/100 g.

From the viewpoint of improving engraving sensitivity by efficiently transmitting heat generated by photothermal conversion to the surrounding polymer, etc., the carbon black is preferably a conductive carbon black having a specific surface area of at least 100 m²/g.

Component E in the resin composition for laser engraving of the present invention may be used singly or in a combination of two or more compounds.

The content of the photothermal conversion agent capable in the resin composition for laser engraving of the present invention largely depends on the size of the molecular extinction coefficient characteristic to the molecule, and is preferably 0.01 to 20 mass % relative to the total solids content of the resin composition, more preferably 0.05 to 10 mass %, and yet more preferably 0.1 to 5 mass %.

### <(Component F) Fragrance>

In order to reduce odor, the resin composition for laser engraving of the present invention preferably comprises a fragrance. A fragrance is effective in reducing odor when producing a flexographic printing plate precursor or when carrying out laser engraving.

As the fragrance, a known fragrance may be used by appropriate selection; one type of fragrance may be used on its own, or a plurality of fragrances may be used in combination.

The fragrance is preferably selected as appropriate according to the other component of resin composition and it is preferable to carry out optimization by combining known fragrances. Examples of the fragrance include fragrances described in ‘Gosei Koryo—Kagaku To Shohin Chishiki—(Synthetic Fragrances—Chemistry and Product Knowledge—)’ (Motoichi Indo, The Chemical Daily Co., Ltd.), ‘Koryo Kagaku Nyumon (Introduction to Fragrance Chemistry)’ (Shoji Watanabe, Baifukan), ‘Kaori no Hyakka’ (Encyclopedia of Fragrances) (Ed. by Japan Perfumery & Flavoring Association, Asakura Publishing Co., Ltd.), and ‘Koryo Kagaku Soran II (Complete Fragrance Chemistry II) Isolated Fragrances/Synthetic Fragrances/Applications of Fragrances’ (Hirokawa-Shoten Ltd.).

Examples of the fragrance that can be used in the present invention include fragrances described in paragraphs 0012 to 0025 of JP-A-2009-203310, and paragraphs 0081 to 0089 of JP-A-2011-245818.

The content of a fragrance of resin composition for laser engraving in the present invention is preferably 0.003 to 1.5 mass % relative to the total weight on a solids content basis of the resin composition, and more preferably 0.005 to 1.0 mass %. When in the above-mentioned range, a masking effect can be exhibited fully, the odor of the fragrance is appropriate, the operating environment can be improved, and engraving sensitivity is excellent.

### (Component G) Solvent

The resin composition for laser engraving of the present invention may comprise (Component G) a solvent.

From the viewpoint of dissolving each of the components, a solvent is preferably mainly an aprotic organic solvent. More specifically, solvents are used preferably at aprotic organic solvent/protic organic solvent=100/0 to 50/50 (ratio by mass), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is preferable.

The content of the solvents is not particularly limited, and solvents necessary for forming a relief-forming layer. may be added. Meanwhile, the solid mass content of the resin composition means the content except for the solvents in the resin composition.

### (Component H) Filler

The resin composition for laser engraving of the present invention may comprise (Component H) a filler in order to improve the physical properties of a cured film of the resin composition for laser engraving.

As the filler, a known filler may be used, and examples thereof include inorganic particles and organic resin particles.

As the inorganic particles, known particles may be used, and examples thereof include carbon nanotubes, fullerene, graphite, silica, alumina, aluminum, and calcium carbonate.

As the organic resin particles, known particles may be used, and preferred examples thereof include thermally expandable microcapsules.

As the thermally expandable microcapsules, EXPANCEL (Akzo Noble) can be cited.

The resin composition for laser engraving of the present invention may employ only one type of Component H or two or more types in combination.

The content of the filler (Component H) in the resin composition for laser engraving of the present invention is preferably 0.01 to 20 mass % relative to the total solids content of the resin composition, more preferably 0.05 to 10 mass %, and particularly preferably 0.1 to 5 mass %.

### (Component I) Binder Polymer Except Component a

The resin composition for laser engraving of the present invention may comprise (Component I) a binder polymer except Component A(hereinafter, also called simply a ‘binder polymer’) that is a resin component other than Component A, but the content thereof is preferably less than the content of Component A, more preferably no greater than 50 mass % of the content of Component A, yet more preferably no greater than 10 mass %, and particularly preferably none, that is, the binder polymer except Component A (Component I) being not contained.

The binder polymer is a polymer component contained in the resin composition for laser engraving; a usual polymer compound is appropriately selected, and one type may be used on its own or two or more types may be used in combination. In particular, when the resin composition for laser engraving is used in a printing plate precursor, it is preferably selected while taking into consideration various aspects of performance such as laser engraving properties, ink acceptance/transfer, and engraving residue dispersibility.

Examples of the binder polymer include binder polymers described in paragraphs 0009 to 0030 of JP-A-2012-045801.

The resin composition for laser engraving of the present invention may employ only one type of Component I or two or more types in combination.

### <Other Additives>

To the resin composition for laser engraving of the present invention, additives other than Component A to Component I may be added suitably in a range that does not hinder the effect of the present invention. Examples thereof include thickener, surfactant, wax, a process oil, a metal oxide, an ozone decomposition inhibitor, an antioxidant, a thermal polymerization inhibitor, a colorant, a alocohol exchange reaction catalyst, etc. With regard to these additives, only one type may be used or two or more types may be used in combination.

The resin composition for laser engraving of the present invention may comprise, as an additive for improving engraving sensitivity, nitrocellulose or a high thermal conductivity material.

Since nitrocellulose is a self-reactive compound, it generates heat during laser engraving, thus assisting thermal decomposition of a coexisting binder polymer. It is surmised that as a result, the engraving sensitivity improves.

A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition. (Flexographic printing plate precursor for laser engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light or heat.

In the present invention, the ‘relief-forming layer’ means a layer in a state before being crosslinked, that is, a layer formed from the resin composition for laser engraving of the present invention, which may be dried as necessary. The ‘flexographic printing plate’ is made by laser engraving the flexographic printing plate precursor having the crosslinked relief-forming layer.

In the present invention, the “crosslinked relief-forming layer” refers to a layer obtained by crosslinking the aforementioned relief-forming layer. The crosslinking can be performed by heat and/or light, and the crosslinking by heat is preferable. Moreover, the crosslinking is not particularly limited only if it is a reaction that cures the resin composition, and is a general idea that includes the crosslinked structure by the reaction of Component A with each other, the reaction of Component B with each other, the reaction between Component A and Component B, and the reaction between Component B and other component etc.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The flexographic printing plate precursor for laser engraving may further comprise, as necessary, an adhesive layer between the support and the (crosslinked) relief-forming layer and, above the (crosslinked) relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

The process for producing a flexographic printing plate precursor for laser engraving is not particularly limited, and examples thereof include a method in which a coating solution of a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, is cast onto a support, and this is dried in an oven to thus remove solvent.

The resin composition for laser engraving may be produced by, for example, dissolving or dispersing Component A and Component B, and as optional components Component C to Comoponent I, etc. in an appropriate solvent, and then mixing the solution. Since it is preferably to remove most of the solvent component in a stage of producing a flexographic printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is a production process comprising a crosslinking step of crosslinking the relief-forming layer by means of heat to thus obtain a flexographic printing plate precursor having a crosslinked relief-forming layer.

The relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

Due to the relief-forming layer being thermally crosslinked, firstly, a relief formed after laser engraving becomes sharp and, secondly, tackiness of engraving residue formed during laser engraving is suppressed.

In the present invention, in the crosslinking step, polymerization reactions between Component A, between Component B and between Component A and Component B carry out.

In addition, by using a photopolymerization initiator or the like, the polymerizable compound may be polymerized to form crosslinking, and the crosslinking may be further carried out by means of light.

When the relief-forming layer comprises a photopolymerization initiator, the relief-forming layer may be crosslinked by irradiating the relief-forming layer with actinic radiation that triggers the photopolymerization initiator.

It is standard to apply light to the entire surface of the relief-forming layer. Examples of the light (also called ‘actinic radiation’) include visible light, UV light, and an electron beam, but UV light is most generally used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

### (Flexographic Printing Plate and Process for Making Same)

The process for making a flexographic printing plate of the present invention preferably comprises a layer formation step of forming a relief-forming layer from the resin composition for laser engraving of the present invention, a crosslinking step of crosslinking the relief-forming layer by means of heat to thus form a flexographic printing plate precursor having a crosslinked relief-forming layer, and an engraving step of laser-engraving the flexographic printing plate precursor having the crosslinked relief-forming layer.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The relief printing plate of the present invention may suitably be printable by a UV ink and an aqueous ink.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, and particularly preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention is preferably aqueous rinsing liquid comprising water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is available when it is carried out by a letterpress printer using any of aqueous, oil-based, and UV inks, and printing is also possible when it is carried out by a flexographic printer using a UV ink. The flexographic printing plate of the present invention has excellent printing durability, and printing can be carried out for a long period of time without plastic deformation of the relief layer or degradation of printing durability.

### EXAMPLE

The present invention is explained in further detail below by reference to Examples, but the present invention should not be construed as being limited to these Examples. Furthermore, ‘parts’ in the description below means ‘parts by mass’, and ‘%’ means ‘mass %’, unless otherwise specified.

Moreover, the weight-average molecular weight (Mw) and the number-average molecular weight (Mn) of a polymer in the Examples are values measured by a Gel Permeation Chromatography (GPC) method (eluent: tetrahydrofuran) unless otherwise specified.

### Synthetic Examples

### Synthesis of B3

Dicyclohexylcarbodiimide (Tokyo Chemical Industry Co., Ltd.) (18 g) was added to a solution of methacrylic acid (Tokyo Chemical Industry Co., Ltd.) (5 g), tricyclohexylmethanol (ALDRICH) (22.5 g), and N,N-dimethyl-4-aminopyridine (Tokyo Chemical Industry Co., Ltd.) (0.5 g) in methylene chloride (150 g) at 0° C. over 30 min. After the addition, stirring was carried out at room temperature (25° C.) for a further 4 hours. The reaction solution was washed three times with water and once with saturated brine, then dried over magnesium sulfate, filtered, and concentrated, thus giving B-3.

### Synthesis of B-4

Under a flow of nitrogen, acryloyl chloride (Tokyo Chemical Industry Co., Ltd.) (15 g) was added dropwise to a solution of 2,2-bis(hydroxymethyl)propionic acid (Tokyo Chemical Industry Co., Ltd.) (10 g) and triethylamine (25 g) in methylene chloride (150 g) at room temperature over 1 hour. After the dropwise addition, stirring was carried out at room temperature for a further 2 hours. The reaction solution was washed three times with water and then dried over magnesium sulfate, and the magnesium sulfate was removed by filtration. tert-Butanol (Tokyo Chemical Industry Co., Ltd.) (6 g) and N,N-dimethyl-4-aminopyridine (Tokyo Chemical Industry Co., Ltd.) (0.5 g) were added to the filtrate, and the solution was then cooled to 0° C. Subsequently, dicyclohexylcarbodiimide (Tokyo Chemical Industry Co., Ltd.) (18 g) was added to the reaction solution over 30 min. After the addition, stirring was carried out at room temperature for a further 4 hours. The reaction solution was washed three times with water and once with saturated brine, then dried over magnesium sulfate, filtered, and concentrated, thus giving B-4.

### Synthesis of B-5

Dicyclohexylcarbodiimide (Tokyo Chemical Industry Co., Ltd.) (18 g) was added to a solution of Light-Ester HO-MS (N) (Kyoeisha Chemical Co., Ltd.) (4.1 g), 1-adamantanol (Tokyo Chemical Industry Co., Ltd.) (12.3 g), and N,N-dimethyl-4-aminopyridine (Tokyo Chemical Industry Co., Ltd.) (0.5 g) in methylene chloride (150 g) at 0° C. over 30 min. After the addition, stirring was carried out at room temperature for a further 4 hours. The reaction solution was washed three times with water and once with saturated brine, then dried over magnesium sulfate, filtered, and concentrated, thus giving B-5.

### Synthesis of B-6

B-6 was obtained in the same manner as in the synthesis of B-5 except that 1-adamantanol (Tokyo Chemical Industry Co., Ltd.) (12.3 g) was changed to tert-butanol (Tokyo Chemical Industry Co., Ltd.) (6 g).

### Synthesis of B-7

Under a flow of nitrogen, methacryloyl chloride (Tokyo Chemical Industry Co., Ltd.) (7.5 g) was added dropwise to a solution of 4-hydroxycyclohexanecarboxylic acid (Tokyo Chemical Industry Co., Ltd.) (10.7 g) and triethylamine (12.5 g) in methylene chloride (150 g) at room temperature over 1 hour. After the dropwise addition, stirring was carried out at room temperature for a further 2 hours. The reaction solution was washed three times with water and then dried over magnesium sulfate, and the magnesium sulfate was removed by filtration. tert-Butanol (Tokyo Chemical Industry Co., Ltd.) (6 g) and N,N-dimethyl-4-aminopyridine (Tokyo Chemical Industry Co., Ltd.) (0.5 g) were added to the filtrate, and the solution was then cooled to 0° C. Subsequently, dicyclohexylcarbodiimide (Tokyo Chemical Industry Co., Ltd.) (18 g) was added to the reaction solution over 30 min. After the addition, stirring was carried out at room temperature for a further 4 hours. The reaction solution was washed three times with water and once with saturated brine, then dried over magnesium sulfate, filtered, and concentrated, thus giving B-7.

### Synthesis of A-1

tert-Butyl methacrylate (Wako Pure Chemical Industries, Ltd.) (100 g) and a solution of V-65 (2,2′-azobis(2,4-dimethylvaleronitrile), Wako Pure Chemical Industries, Ltd.) (1.75 g) in ethanol (75 g) were added dropwise under a flow of nitrogen to ethanol (75 g) at 75° C. over 2.5 hours. After the dropwise addition, stirring was carried out at 75° C. for 2 hours. The temperature was increased to 78° C., stirring was carried out for 90 min., and V-65 (Wako Pure Chemical Industries, Ltd.) (1.62 g) was then added. Subsequently, stirring was carried out while heating at 78° C. for 2 hours, thus giving an ethanol solution of A-1.

1.0 g of the ethanol solution of A-1 thus obtained was weighed, placed together with 10 g of sea sand in an aluminum cup, and mixed well therewith, and the mixture was heated in an oven at 130° C. under reduced pressure (no greater than 5 mmHg) for 2 hours. The solids content concentration of A-1 was calculated from the change in weight between that before and that after heating and was found to be 41.3%.

Identification of A-1 was carried out by gel permeation chromatography and IR spectrum. The weight-average molecular weight was 20,000 on a polystyrene basis.

### Examples 1 to 24 and Comparative Examples 1 to 5

### 1. Preparation of Resin Composition for Laser Engraving

A three-necked flask equipped with a stirring blade and a condenser was charged with Component A, Component B, and Component C described in Table 1 or 2, and this mixture was heated at 70° C. while stirring for 30 min.

Subsequently, the mixture was allowed to cool to 40° C., 1 part by mass of Component D described in Table 1 or 2 and 3 parts by mass of Component E described in Table 1 or 2 were added and stirring was carried out for 30 min.

Subsequently, 0.1 mass % (relative to the total solids content of the resin composition) of isobornyl acetate (Wako Pure Chemical Industries, Ltd.) was added as a fragrance, and stirring was carried out at 40° C. for 10 min.

This operation gave the corresponding flowable coating solution for a crosslinkable relief-forming layer (resin composition for laser engraving). When ‘-’ is given in Table 1 or 2, the corresponding component was not added in the above operations (the portion of mass that was not added was compensated for by increasing the total amount added while maintaining unchanged the ratio of amounts added of other materials).

### 2. Preparation of Flexographic Printing Plate Precursor for Laser Engraving

A spacer (frame) having a predetermined thickness was placed on a PET substrate, the resin composition for laser engraving of each of Examples 1 to 24 and Comparative Examples 1 to 5 was gently cast so that it did not overflow from the spacer (frame), and heated in an oven at 90° C., thus providing a relief-forming layer having a thickness of about 1 mm and producing the corresponding flexographic printing plate precursor for laser engraving. In this process, heating was carried out in the oven at 90° C. until surface tackiness completely disappeared, thus carrying out thermal crosslinking.

### 3. Preparation of Flexographic Printing Plate

A crosslinked relief-forming layer was engraved using the two types of lasers below.

As a carbon dioxide laser engraving machine, engraving by irradiation with a laser was carried out using an ML-9100 series high quality CO₂ laser marker (Keyence Corporation). A flexographic printing plate precursor for laser engraving was subjected to raster-engraving of a 1 cm square solid printed area using the carbon dioxide laser engraving machine under conditions of an output of 12 W, a head speed of 200 mm/sec, and a pitch setting of 2,400 DPI.

As a semiconductor laser engraving machine, laser recording equipment with a fiber-coupled semiconductor laser (FC-LD) SDL-6390 (JDSU, wavelength 915 nm) with a maximum output of 8.0 W was used. A 1 cm square solid printed area was raster-engraved using the semiconductor laser engraving machine under conditions of an output of 7.5 W, a head speed of 409 mm/sec, and a pitch setting of 2,400 DPI.

The thickness of a relief layer of each of the flexographic printing plates of Examples 1 to 24 and Comparative Examples 1 to 5 thus obtained was about 1 mm.

Furthermore, when the Shore A hardness of the relief layer was measured by the above measurement method, it was found to be 75°.

### 4. Evaluation of Flexographic Printing Plates

The performance of a flexographic printing plate was evaluated in terms of items below, and the results are shown in Table 1 or 2.

### (4-1) Rinsing Properties for Engraving Residue

A laser-engraved plate was immersed in water, and an engraved part was rubbed with a toothbrush (Clinica toothbrush flat, Lion Corporation) 10 times. Subsequently, the presence or absence of residue on the surface of the relief layer was examined using an optical microscope. When there was no residue the evaluation was 5, when there was almost no residue the evaluation was 4, when there was some residue the evaluation was 3, when there was residue but there was no problem in practice the evaluation was 2, and when residue could not be removed the evaluation was 1.

### (4-2) Breaking Strength

A cured film (relief layer) obtained by curing a resin composition for laser engraving of each of the Examples and Comparative Examples was subjected to measurement of breaking strength as follows.

As a tensile tester, a Shimadzu AGSH5000 manufactured by Shimadzu Corporation was used, and measurement was carried out by processing a test piece into a dumbbell shape in accordance with JIS (measured by inputting a width average of 2.25 cm). The measurement environment was temperature: about 21° C., humidity: 60%, stretching speed: 2 mm/min.

### (4-3) Storage Modulus of Elasticity

A sample was formed by peeling off a crosslinked relief-forming layer from a flexographic printing plate precursor and subjected to measurement of storage modulus of elasticity E′ at 100 Hz and 25° C. using a Rheogel-E4000 (UBM). When the value for E′ was in the range of at least 1.0 MPa but no greater than 40.0 MPa, it was good, and one in the range of at least 1.0 MPa but no greater than 20.0 MPa was better.

TABLE 1

| | | | | | | | | | rinsing | | Storage |
|---|---|---|---|---|---|---|---|---|---|---|---|
| | Component A | | Component B | | Component C | | | photo- | properties | | modulus |
| | | adding | | adding | | adding | polymeriza | thermal | for | Breaking | of |
| | | amount | | amount | | amount | -tion | conversion | engraving | strength | elasticity |
| | compound | (parts) | compound | (parts) | compound | (parts) | initiator | agent | residue | (N/mm²) | (MPa) |
| Ex. 1 | UV-3000B | 100 | B-1 | 20 | A—HD—N | 10 | PBZ | CB | 5 | 306 | 18.3 |
| Ex. 2 | BAC-45 | 100 | B-1 | 20 | A—HD—N | 10 | PBZ | CB | 4 | 246 | 17.9 |
| Ex. 3 | LIR-30 | 100 | B-1 | 20 | A—HD—N | 10 | PBZ | CB | 4 | 238 | 13.4 |
| Ex. 4 | LIR-30 | 100 | B-1 | 5 | A—HD—N | 10 | PBZ | CB | 2 | 261 | 15.1 |
| Ex. 5 | LIR-30 | 100 | B-1 | 40 | A—HD—N | 10 | PBZ | CB | 4 | 193 | 11.5 |
| Ex. 6 | LIR-30 | 100 | B-1 | 60 | A—HD—N | 10 | PBZ | CB | 5 | 162 | 9.6 |
| Ex. 7 | LIR-30 | 100 | B-2 | 20 | A—HD—N | 10 | PBZ | CB | 4 | 229 | 13.8 |
| Ex. 8 | LIR-30 | 100 | B-3 | 20 | A—HD—N | 10 | PBZ | CB | 3 | 247 | 14.7 |
| Ex. 9 | LIR-30 | 100 | B-1 | 20 | — | 0 | PBZ | CB | 4 | 146 | 4.9 |
| Ex. 10 | LIR-30 | 100 | B-1 | 20 | TEGDMA | 10 | PBZ | CB | 4 | 218 | 14.3 |
| Ex. 11 | LIR-30 | 100 | B-1 | 20 | GMA | 10 | PBZ | CB | 4 | 206 | 17.2 |
| Ex. 12 | LIR-30 | 100 | B-1 | 20 | DPHA | 10 | PBZ | CB | 4 | 245 | 35.4 |
| Ex. 13 | LIR-30 | 100 | B-4 | 20 | — | 0 | PBZ | CB | 4 | 220 | 14.2 |
| Ex. 14 | LIR-30 | 100 | B-4 | 20 | A—HD—N | 10 | PBZ | CB | 4 | 211 | 18.0 |
| Comp. | LIR-30 | 100 | — | 0 | A—HD—N | 20 | PBZ | CB | 1 | 247 | 12.7 |
| Ex. 1 | | | | | | | | | | | |
| Comp. | BI-3000 | 100 | B-1 | 20 | A—HD—N | 10 | PBZ | CB | Evaluation not possible | | |
| Ex. 2 | | | | | | | | | | | |
| Comp. | A-1 | 100 | — | 0 | A—HD—N | 10 | PBZ | CB | 5 | 124 | 279.3 |
| Ex. 3 | | | | | | | | | | | |
| Comp. | BL-7Z | 100 | B-1 | 20 | A—HD—N | 10 | PBZ | CB | 4 | 129 | 364.1 |
| Ex. 4 | | | | | | | | | | | |

TABLE 2

| | | | | | | | | | rinsing | | |
|---|---|---|---|---|---|---|---|---|---|---|---|
| | Component A | | Component B | | Component C | | | photo- | properties | | Storage |
| | | adding | | adding | | adding | polymeriza- | thermal | for | Breaking | modulus of |
| | | amount | | amount | | amount | tion | conversion | engraving | strength | elasticity |
| | compound | (parts) | compound | (parts) | compound | (parts) | initiator | agent | residue | (N/mm²) | (MPa) |
| Ex. 15 | LIR-30 | 100 | B-1 | 20 | HEMA | 10 | PBZ | CB | 4 | 151 | 2.7 |
| Ex. 16 | UBEPOL | 100 | B-1 | 20 | A—HD—N | 10 | — | CB | 3 | 266 | 18.6 |
| | BR 150 | | | | | | | | | | |
| Ex. 17 | LIR-30 | 100 | B-1 | 20 | A—HD—N | 10 | PBZ | — | 4 | 164 | 7.1 |
| Ex. 18 | UBEPOL | 100 | B-1 | 20 | A—HD—N | 10 | — | — | 3 | 230 | 16.1 |
| | BR 150 | | | | | | | | | | |
| Ex. 19 | LIR-30 | 100 | B-2 | 20 | A—HD—N | 10 | PCD | CB | 4 | 233 | 17.7 |
| Ex. 20 | LBR-305 | 100 | B-1 | 20 | A—HD—N | 10 | PBZ | CB | 4 | 214 | 15.6 |
| Ex. 21 | EA-3000 | 100 | B-1 | 20 | A—HD—N | 10 | PBZ | CB | 4 | 267 | 19.3 |
| Ex. 22 | LIR-30 | 100 | B-5 | 20 | A—HD—N | 10 | PBZ | CB | 3 | 229 | 15.8 |
| Ex. 23 | LIR-30 | 100 | B-6 | 20 | A—HD—N | 10 | PBZ | CB | 3 | 237 | 17.0 |
| Ex. 24 | LIR-30 | 100 | B-7 | 20 | A—HD—N | 10 | PBZ | CB | 3 | 212 | 19.6 |
| Comp. | LIR-30 | 100 | HEMA | 20 | A—HD—N | 20 | PBZ | CB | 1 | 136 | 3.2 |
| Ex. 5 | | | | | | | | | | | |

Details of components in Table 1 or 2 are as follows.

UV-3000B: Shikoh UV-3000B, urethane acrylate oligomer (containing a main chain terminal (meth)acryloyl group, a plastomer at 20° C., Mn=10,000, The Nippon Synthetic Chemical Industry Co., Ltd.)

BAC-45: terminal acrylic-modified polybutadiene (polybutadiene diacrylate, Mn=4,500) (Osaka Organic Chemical Industry Ltd.)

LIR-30: polyisoprene (Mn=29,200, Kuraray Co., Ltd.)

BI-3000: hydrogenated polybutadiene (Mn=5,300, Nippon Soda Co., Ltd.)

A-1: poly-tert-butyl methacrylate (Mn=15,500, synthesized product)

BL-7Z: polyvinylbutyral (Mn=40,000, Sekisui Chemical Co., Ltd.)

UBEPOL BR 150: polybutadiene (Mn=222,000, Ube Industries, Ltd.)

LBR-305: polybutadiene (Mn=27,500, Kuraray Co., Ltd.)

EMA-3000: acrylate-modified polybutadiene (polybutadiene containing acryloxyethyl group at both termini, Mn=5,500) (Nippon Soda Co., Ltd.)

B-1: tert-butyl methacrylate (Wako Pure Chemical Industries, Ltd.)

B-2: 2-methyl-2-adamantyl methacrylate (Tokyo Chemical Industry Co., Ltd.)

B-3: tert-butyl 2-methacryloyloxyethylhexahydrophthalate (synthesized product)

B-4: tert-butyl 2,2-bis(acryloyloxymethyl)propionate (synthesized product)

B-5: compound below (synthesized product)

B-6: compound below (synthesized product)

B-7: compound below (synthesized product)

[chemical structure]

A-HD-N: 1,6-hexanediol diacrylate (Shin-Nakamura Chemical Co., Ltd.)

TEGDMA: triethylene glycol dimethacrylate (Tokyo Chemical Industry Co., Ltd.)

GMA: glycerol dimethacrylate (Wako Pure Chemical Industries, Ltd.)

DPHA: dipentaerythritol hexaacrylate (ALDRICH)

HEMA: 2-hydroxyethyl methacrylate (Tokyo Chemical Industry Co., Ltd.)

PBZ: Perbutyl Z, t-butyl peroxybenzoate (NOF Corporation)

PCD: Percumyl D, dicumyl peroxide (NOF Corporation)

CB: carbon black #45L (Mitsubishi Chemical Corporation, particle size: 24 nm, specific surface area: 125 m²/g, DBP oil adsorption: 45 cm³/100 g)

1. A resin composition for laser engraving, comprising:
(Component A) an ethylenically unsaturated group-containing binder polymer; and
(Component B) a tertiary ester group- and ethylenically unsaturated group-containing compound.

2. The resin composition for laser engraving according to claim 1, wherein the tertiary ester group is a group represented by Formula (I) [chemical structure]
wherein in Formula (I) R¹ to R³ independently denote a monovalent hydrocarbon group, at least two of R¹ to R³ may be bonded to each other to form at least one ring structure, and the wavy line portion denotes a position of bonding to another moiety.

3. The resin composition for laser engraving according to claim 1, wherein it further comprises (Component C) a polymerizable compound other than Component A and Component B.

4. The resin composition for laser engraving according to claim 1, wherein it further comprises (Component D) a polymerization initiator.

5. The resin composition for laser engraving according to claim 3, wherein it further comprises (Component D) a polymerization initiator.

6. The resin composition for laser engraving according to claim 1, wherein it further comprises (Component E) a photothermal conversion agent.

7. The resin composition for laser engraving according to claim 5, wherein it further comprises (Component E) a photothermal conversion agent.

8. The resin composition for laser engraving according to claim 1, wherein Component A is a polymer selected from the group consisting of a conjugated diene-based polymer, a terminal ethylenically unsaturated group-containing conjugated diene-based polymer, and an ethylenically unsaturated group-containing polyurethane resin.

9. The resin composition for laser engraving according to claim 1, wherein Component A has a content of 5 to 90 mass %.

10. The resin composition for laser engraving according to claim 1, wherein Component B is a tertiary ester group-containing (meth)acrylate compound.

11. The resin composition for laser engraving according to claim 7, wherein Component B is a tertiary ester group-containing (meth)acrylate compound.

12. The resin composition for laser engraving according to claim 1, wherein Component B is a monofunctional ethylenically unsaturated compound.

13. The resin composition for laser engraving according to claim 1, wherein Component B has a content of 5 to 50 mass % relative to 100 parts by mass of Component A.

14. A flexographic printing plate precursor for laser engraving comprising a relief-forming layer comprising the resin composition for laser engraving according to claim 1.

15. A flexographic printing plate precursor for laser engraving comprising a crosslinked relief-forming layer formed by crosslinking by means of heat a relief-forming layer comprising the resin composition for laser engraving according to claim 1.

16. A process for producing a flexographic printing plate precursor for laser engraving, the process comprising:
a layer formation step of forming a relief-forming layer comprising the resin composition for laser engraving according to claim 1; and
a crosslinking step of crosslinking the relief-forming layer by means of heat to thus obtain a flexographic printing plate precursor comprising a crosslinked relief-forming layer.

17. A process for making a flexographic printing plate, the process comprising:
a step of preparing the flexographic printing plate precursor for laser engraving according to claim 15; and
an engraving step of laser-engraving the crosslinked relief-forming layer to thus form a relief layer.

18. A process for making a flexographic printing plate, the process comprising:
a step of preparing a flexographic printing plate precursor for laser engraving obtained by the production process according to claim 16; and
an engraving step of laser-engraving the crosslinked relief-forming layer to thus form a relief layer.

19. The process for making a flexographic printing plate according to claim 17, wherein it further comprises a rinsing step of rinsing the relief layer surface with an aqueous rinsing liquid after the engraving step.
